(19) United States
(12) Patent Application Publication
(10) Pub. No.: US 2018/0015939 A1
(43) Pub. Date: Jan. 18, 2018

(54) Hand Truck System

(71) Applicant: Kelly Dorman, Houston, TX (US)

(72) Inventor: Kelly Dorman, Houston, TX (US)

(21) Appl. No.: 15/211,567

(22) Filed: Jul. 15, 2016

(51) Int. Cl. B62B 1/14

(52) U.S. Cl. CPC B62B 1/142

(57) ABSTRACT

A hand truck system for retaining an object on a hand truck includes a hand truck has a plate and a pair of rails. The rails are spaced apart from each other. The plate may have an object placed thereon thereby facilitating the hand truck to transport the object. A clamping unit is movably coupled to the hand truck. The clamping unit may secure to object on the hand truck. Thus, the object is inhibited from falling off of the hand truck during transportation.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to hand truck devices and more particularly pertains to a new hand truck device for retaining an object on a hand truck.

### BRIEF SUMMARY OF THE INVENTION

An embodiment of the disclosure meets the needs presented above by generally comprising a hand truck has a plate and a pair of rails. The rails are spaced apart from each other. The plate may have an object placed thereon thereby facilitating the hand truck to transport the object. A clamping unit is movably coupled to the hand truck. The clamping unit may secure to object on the hand truck. Thus, the object is inhibited from falling off of the hand truck during transportation.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a hand truck system according to an embodiment of the disclosure.

FIG. 2 is a perspective in-use view of an embodiment of the disclosure.

FIG. 3 is a cross sectional view taken along line 3-3 of FIG. 2 of an embodiment of the disclosure.

FIG. 4 is a bottom side view of an embodiment of the disclosure.

FIG. 5 is a left side perspective in-use view of an embodiment of the disclosure.

### DETAILED DESCRIPTION OF THE INVENTION

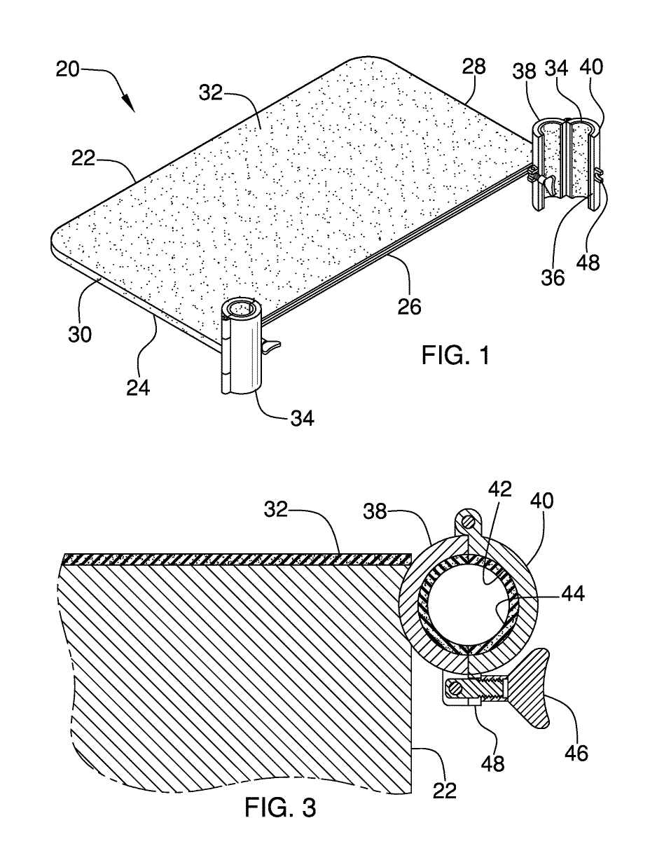

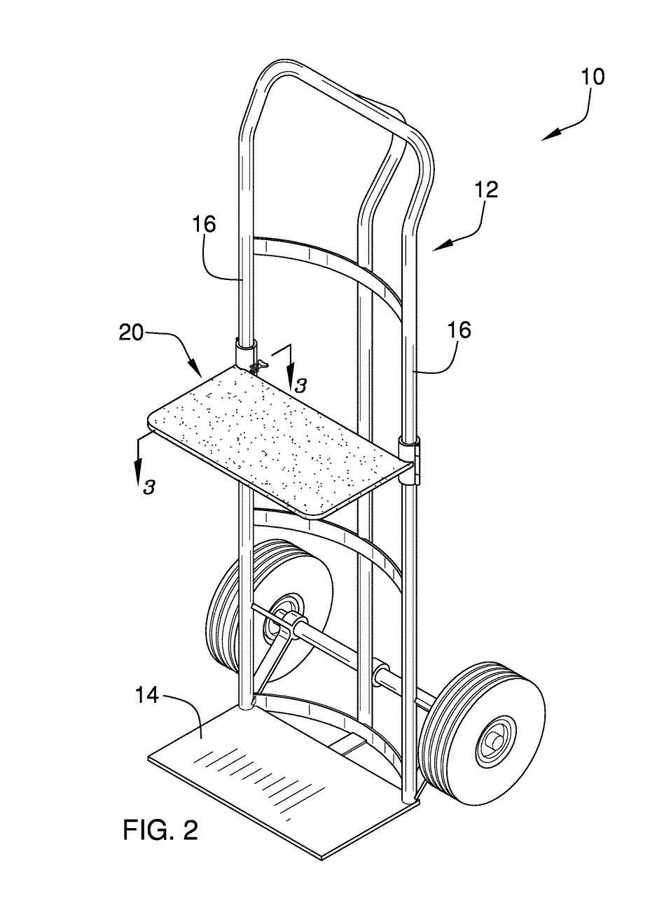

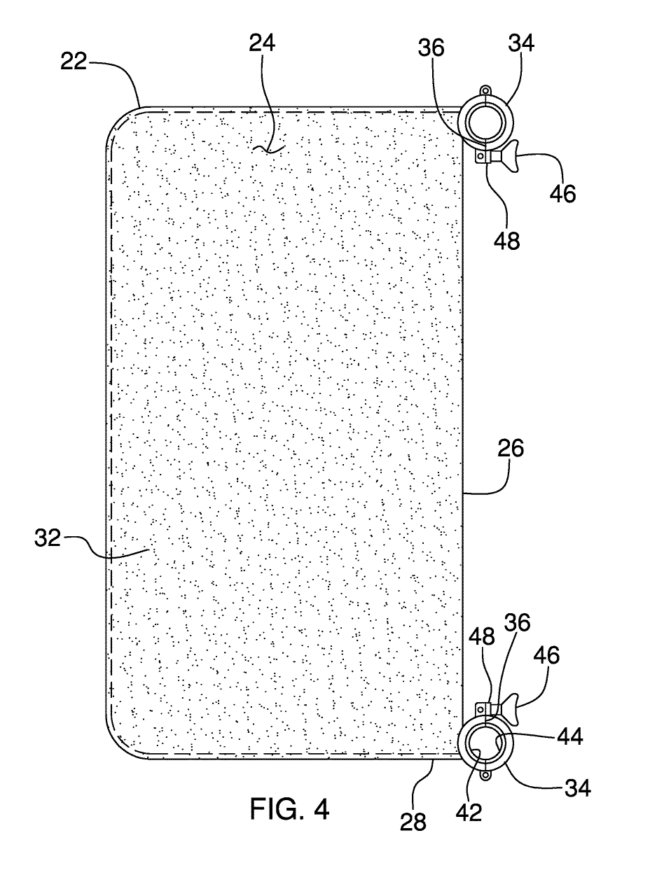

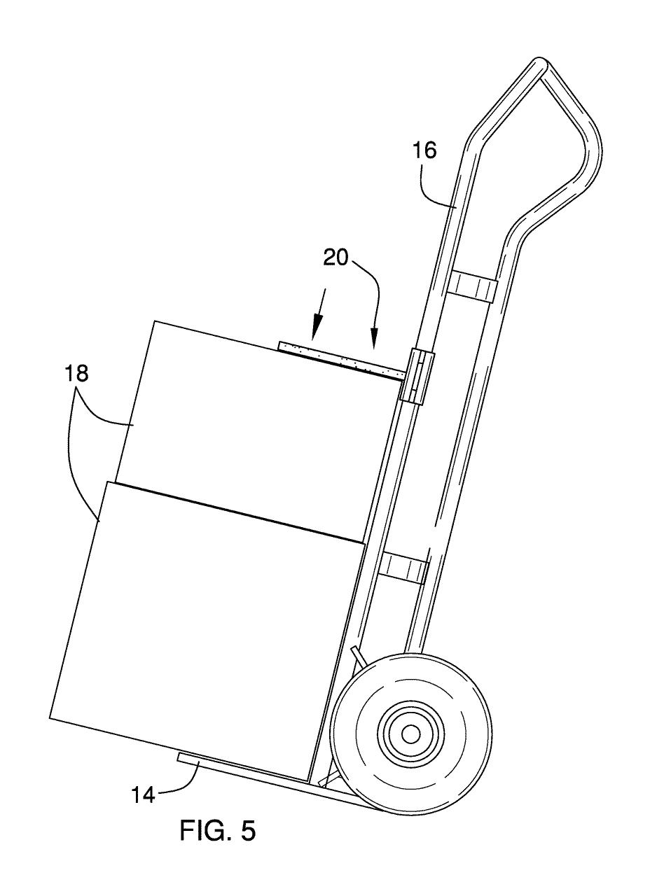

With reference now to the drawings, and in particular to FIGS. 1 through 5 thereof, a new hand truck device embodying the principles and concepts of an embodiment of the disclosure and generally designated by the reference numeral 10 will be described.

As best illustrated in FIGS. 1 through 5, the hand truck system 10 generally comprises a hand truck 12 that has a plate 14 and a pair of rails 16. The rails 16 are spaced apart from each other. The plate 14 may have an object 18 placed thereon thereby facilitating the hand truck 12 to transport the object 18. The hand truck 12 may be a wheeled hand truck or the like.

A clamping unit 20 is provided. The clamping unit 20 is movably coupled to the hand truck 12. The clamping unit 20 may secure the object 18 on the hand truck 12. Thus, the object 18 is inhibited from falling off of the hand truck 12 during transportation.

The clamping unit 20 comprises a panel 22 that has a bottom surface 24, a back edge 26, a first lateral edge 28 and a second lateral edge 30. A rubber coating 32 is positioned on the panel 22. Moreover, the rubber coating 32 completely encompasses the panel 22. Thus, the rubber coating 32 enhances frictionally engaging the object 18.

A pair of sleeves 34 is provided and each of the sleeves 34 is coupled to the panel 22. Each of the sleeves 34 is positioned on the back edge 26 of the panel 22. Each of the sleeves 34 is aligned with an intersecting of an associated one of the first lateral edge 28 and the second lateral edge 30. Each of the sleeves 34 has a cut 36 to define a first half 38 and a second half 40 of each of the sleeves 34. The first half 38 corresponding to each of the sleeves 34 is coupled to the panel 22. The second half 40 corresponding to each of the sleeves 34 is hingedly coupled to the first half 38 of the corresponding sleeve 34.

Each of the sleeves 34 has an inner surface 42. Each of the sleeves 34 is selectively closed around an associated one of the rails 16 of the hand truck 12. Thus, the panel 22 is slidably coupled to the rails 16. The panel 22 is positioned to compress the object 18 between the panel 22 and the plate 14. Thus, the panel 22 may retain the object 18 on the hand truck 12. A rubber coating 44 is positioned on the inner surface 42 of each of the sleeves 34. Thus, the rubber coating 44 enhances frictionally engaging the associated rail 16.

A pair of screws 46 is provided. Each of the screws 46 is hingedly coupled to an associated one of the sleeves 34. Thus, each of the screws 46 may be manipulated. Each of the screws 46 is positioned on the second half 40 of the corresponding sleeve 34.

A pair of saddles 48 is provided. Each of the saddles 48 is coupled to an associated one of the sleeves 34. Moreover, each of the saddles 48 is positioned on the first half 38 of the corresponding sleeve 34. The screw 46 on the corresponding sleeve 34 theadably engages the saddle 48 on the corresponding sleeve 34. Thus, each of the sleeves 34 may compressed around the rails 16 such that the plate 14 is retained a selected distance from the plate 14.

In use, the object 18 is placed on the plate 22 of the hand truck 12. The panel 22 is manipulated such that the bottom surface 24 of the panel 22 abuts the object 18. The screws 46 on each of the sleeves 34 are manipulated to tighten the sleeves 34 around the rails 16. Thus, the panel 22 inhibits the object 18 from tipping off of the hand truck 12 during transportation. Each of the screws 46 is selectively removed from the corresponding saddle 48. Thus, each of the sleeves 34 is selectively removed from the associated rail 16 thereby facilitating the clamping unit 20 to be selectively removed from the hand truck 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hand truck system comprising:
a hand truck having a plate and a pair of rails, said rails being spaced apart from each other, said plate being configured to have an object placed thereon thereby facilitating said hand truck to transport the object;
a clamping unit being movably coupled to said hand truck, said clamping unit including a panel being configured to secure to object on said hand truck thereby inhibiting the object from falling off of said hand truck during transportation;
a pair of sleeves being coupled to said panel, each of said sleeves receiving an associated one of said rails therethrough, each of said sleeves having a first half pivotally coupled to a second half;
a pair of screws, each of said screws having an end being hingedly coupled to an associated one of said sleeves such that said screw is pivotable relative to said sleeve, each of said screws being pivotally coupled to said second half of said corresponding sleeve;
a pair of saddles, each of said saddles being coupled to an associated one of said sleeves, each of said saddles being positioned on said first half of said corresponding sleeve, said screw on said corresponding sleeve being pivotable to be received in said saddle on said first half of said corresponding sleeve; and
each said screw having a head rotatably coupled to a threaded shaft wherein rotation of said head moves said head relative to a length of said threaded shaft, said head abutting said saddle wherein said head is rotatable to urge said first half of said sleeve towards said second half of said sleeve wherein each said sleeve is configured for frictionally securing said panel at a selectable position on said rails.

2. The assembly according to claim 1, wherein said panel includes a bottom surface, a back edge, a first lateral edge and a second lateral edge.

3. The assembly according to claim 2, further comprising each of said sleeves being positioned on said back edge, each of said sleeves being aligned with an intersecting of an associated one of said first lateral edge and said second lateral edge.

4. The assembly according to claim 3, wherein each of said sleeves has a cut to define said first half and said second half of each of said sleeves, said first half corresponding to each of said sleeves being coupled to said panel, said second half corresponding to each of said sleeves being hingedly coupled to said first half of said corresponding sleeve, each of said sleeves having an inner surface, each of said sleeves being selectively positioned around an associated one of said rails of said hand truck such that said panel is slidably coupled to said rails, said panel being positioned to compress the object between said panel and said plate wherein said panel is configured to retain the object on said hand truck.

5. (canceled)

6. (canceled)

7. A hand truck system comprising:
a hand truck having a plate and a pair of rails, said rails being spaced apart from each other, said plate being configured to have an object placed thereon thereby facilitating said hand truck to transport the object; and
a clamping unit being movably coupled to said hand truck, said clamping unit being configured to secure to object on said hand truck thereby inhibiting the object from falling off of said hand truck during transportation, said clamping unit comprising:
a panel having a bottom surface, a back edge, a first lateral edge and a second lateral edge,
a pair of sleeves, each of said sleeves being coupled to said panel, each of said sleeves being positioned on said back edge, each of said sleeves being aligned with an intersecting of an associated one of said first lateral edge and said second lateral edge, each of said sleeves having a cut to define a first half and a second half of each of said sleeves, said first half corresponding to each of said sleeves being coupled to said panel, said second half corresponding to each of said sleeves being hingedly coupled to said first half of said corresponding sleeve, each of said sleeves having an inner surface, each of said sleeves being selectively positioned around an associated one of said rails of said hand truck such that said panel is slidably coupled to said rails, said panel being positioned to compress the object between said panel and said plate wherein said panel is configured to retain the object on said hand truck,
a pair of screws, each of said screws being hingedly coupled to an associated one of said sleeves wherein each of said screws is configured to be manipulated, each of said screws being positioned on said second half of said corresponding sleeve, and
a pair of saddles, each of said saddles being coupled to an associated one of said sleeves, each of said saddles being positioned on said first half of said corresponding sleeve, said screw on said corresponding sleeve theadably engaging said saddle on said corresponding sleeve having each of said sleeves being compressed around said rails such that said plate is retained a selected distance from said plate;
said screw on said corresponding sleeve being pivotable to be received in said saddle on said first half of said corresponding sleeve; and
each said screw having a head rotatably coupled to a threaded shaft wherein rotation of said head moves said head relative to a length of said threaded shaft, said head abutting said saddle wherein said head is rotatable to urge said first half of said sleeve towards said second half of said sleeve wherein each said sleeve is configured for frictionally securing said panel at a selectable position on said rails.
